(19) United States
(12) Patent Application Publication
(10) Pub. No.: US 2013/0246974 A1
(43) Pub. Date: Sep. 19, 2013

(54) System for Content Navigation

(71) Applicants: Leslie Alexandra Weisberg, Los Angeles, CA (US); Adrienne Gail Becker, Beverly Hills, CA (US)

(72) Inventors: Leslie Alexandra Weisberg, Los Angeles, CA (US); Adrienne Gail Becker, Beverly Hills, CA (US)

(21) Appl. No.: 13/798,325

(22) Filed: Mar. 13, 2013

Related U.S. Application Data
(60) Provisional application No. 61/610,283, filed on Mar. 13, 2012.

(51) Int. Cl. G06F 3/0484

(52) U.S. Cl. CPC G06F 3/04842
USPC 715/834

(57) ABSTRACT

An example computing device for online idea collaboration includes: a processor; and a computer readable storage medium encoding instructions that, when executed by the processor, cause the processor to create a user interface including a navigation member having a plurality of content segments, the content segments extending in a circular configuration, with each of the content segments including content, and the navigation member including a center area into which content from one of the content segments is dragged to obtain additional information about that content.

### RELATED APPLICATIONS

This application relates to U.S. patent application Ser. No. 29/415,694, titled “User Interface for Content Navigation” and filed on Mar. 13, 2012.

### BACKGROUND

Users navigate content in many different ways. In an online environment, users follow web links to browse and select desired content for review, such as articles and pictures. For content stored on users' hard drives, the users can browse small representations of the contents of documents, such as thumbnails or icons. In a more traditional context, users can serially scan through content and/or submit queries to identify desired content.

### SUMMARY

In one aspect, a computing device for online idea collaboration includes: a processor; and a computer readable storage medium encoding instructions that, when executed by the processor, cause the processor to create a user interface including a navigation member having a plurality of content segments, the content segments extending in a circular configuration, with each of the content segments including content, and the navigation member including a center area into which content from one of the content segments is dragged to obtain additional information about that content.

In another aspect, a

9. A system includes: a server computing device that receives a request for content from a client, the server computing device including: a processor; and a computer readable storage medium encoding instructions that, when executed by the processor, cause the processor to create a user interface including a navigation member having a plurality of content segments, the content segments extending in a circular configuration, with each of the content segments including content, and the navigation member including a center area into which content from one of the content segments is dragged to obtain additional information about that content.

In yet another aspect, a method of accessing content includes: providing, by a computing device, a navigation member having a plurality of content segments, the content segments extending in a circular configuration, with each of the content segments including content; allowing a user to drag content from one of the content segments into a center of the navigation member; and providing additional information regarding the content from the one of the content segments dragged into the center.

### DESCRIPTION OF THE DRAWINGS

FIG. 1 shows an example system for navigating content.

FIG. 2 shows an example user interface of the system of FIG. 1.

FIG. 3 shows another example user interface of the system of FIG. 1.

FIG. 4 shows another example user interface of the system of FIG. 1.

FIG. 5 shows another example user interface of the system of FIG. 1.

FIG. 6 shows an example method for navigating content.

### DETAILED DESCRIPTION

This application is directed to systems and methods for navigating content. Examples of content include images, video, audio, and text, and combinations thereof.

In example embodiments, a user interface is provided that allows a user to navigate content. The interface is configured to allow the user to navigate the content in an intuitive and efficient manner. The user can also select desired content to obtain additional information about the selected content.

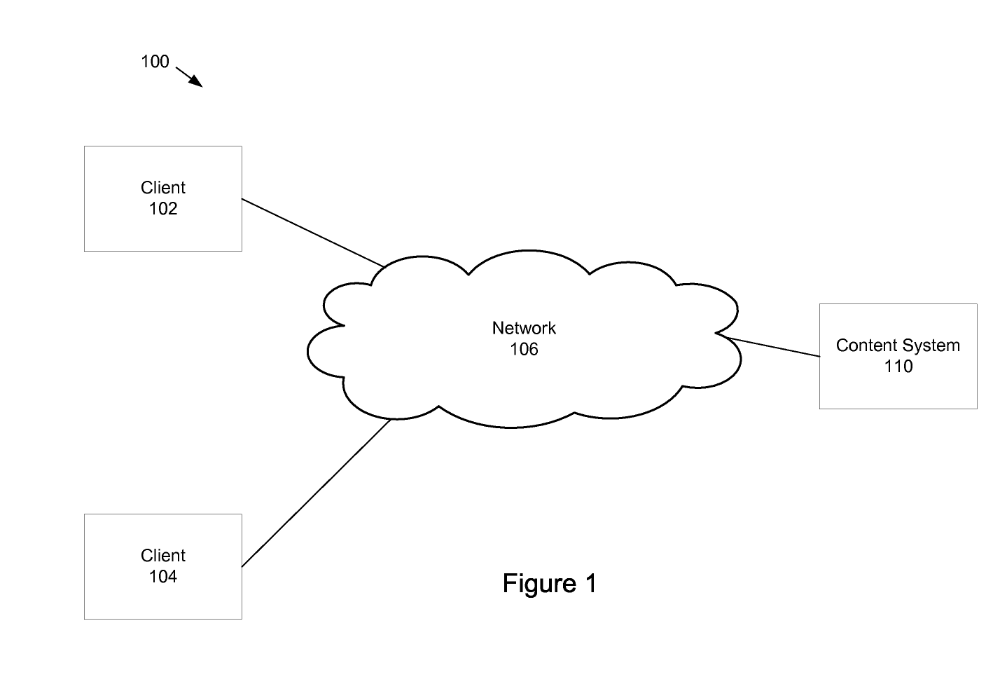

Referring now to FIG. 1, an example system 100 is shown that supports the navigation of content in an online environment. The example system 100 includes clients 102, 104, a network 106, and a system 110 for navigating content.

In example embodiments, the clients 102, 104 and the system 110 are each computing devices, such as a desktop computer, laptop computer, personal data assistant, or cellular device. The clients can include input/output devices, a central processing unit (“CPU”) or processor, a data storage device, and a network device. Typical input/output devices include keyboards, mice, displays, microphones, speakers, disk drives, CD-ROM drives, and flash drives.

Computer readable media, such as a data storage device, provides for data retention. Computer readable media can include computer readable storage media and communication media.

Computer readable storage media are physical media that include volatile and nonvolatile, removable and non-removable media implemented in any method or technology for storage of information such as computer readable instructions, data structures, program modules or other data.

Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

Among the plurality of information stored on the data storage device is a client operating system (“OS”) and client applications. The client OS is a program that manages the hardware and software resources of the computing device. The client applications utilize the resources of the clients 102, 104 and the system 110 to directly perform tasks specified by the user.

The network 106 is a local area network or the Internet. The network 106 enables the clients 102, 104 to send and receive data to/from the system 110. In the example shown, the system 110 includes a web server that is accessible through the network 106. The system 110 hosts a plurality of files and applications. Individuals can use applications running on the clients 102, 104, such as an Internet web browser, to access the system 110. Other configurations for the clients 102, 104, the network 106, and the system 110 are possible.

In example embodiments, users of the clients 102, 104 use an application to access content on the system 100. In such examples, the users can access interfaces on an application, such as a browser, to navigate content and select content for additional information.

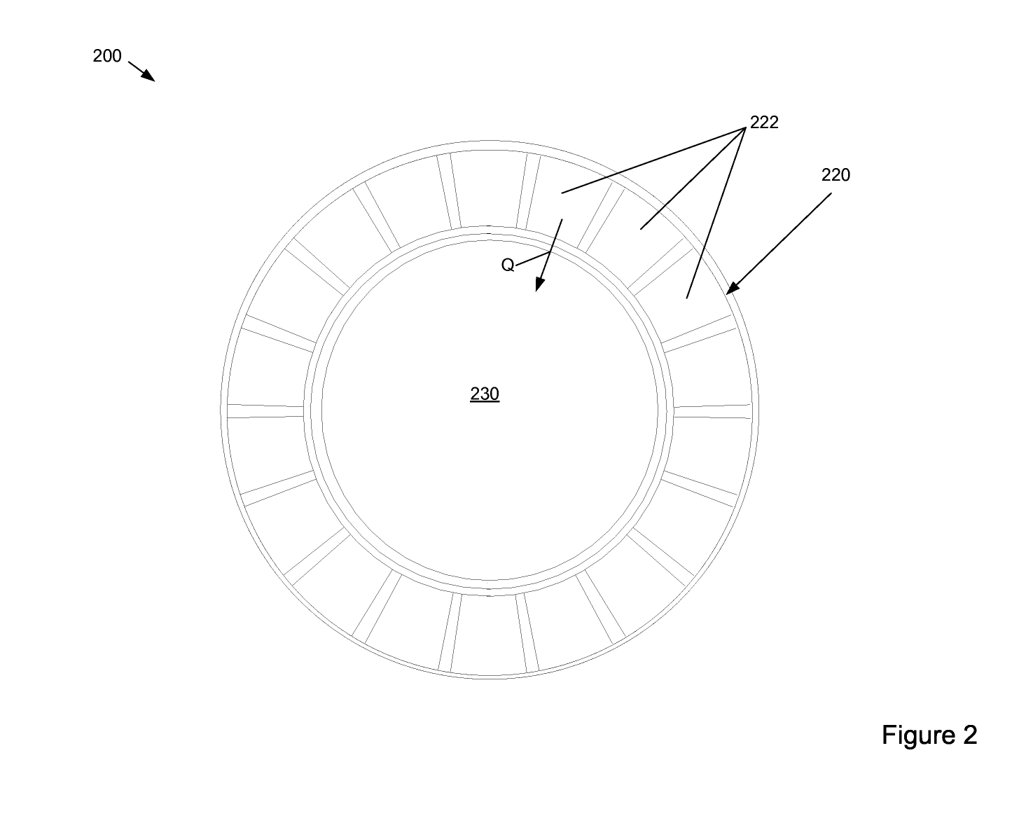

Referring now to FIG. 2, an example user interface 200 is shown. Generally, the interface 200 is used to navigate content to select desired content for more information.

The interface 200 includes a navigation member 220. The navigation member 220 is segmented into a plurality of content segments 222. In this example, the content segments 222 extend in a circle. Typically, each of the content segments 222 includes content, such as images, video, audio, and/or text, or combinations thereof.

The navigation member 220 also includes a center area 230. In this embodiment, the user can drag content in a direction Q (e.g., using a mouse and/or touch controls) from one of the content segments 222 into the center area 230. Upon this action, additional information about the selected content is provided as described below.

In this example, the navigation member 220 is generally shaped in the form of an iris, and the action of dragging the content into the center area 230 is symbolic of bringing that content into focus.

In example embodiments, content in the content segments 222 is updated at a periodic interval, such as every 5 seconds, 10 seconds, 30 seconds, or 1 minute. Each content segment 222 can be updated at the same time, or updating of the content segments 222 can be staggered.

In one example, the content shown in each of the content segments 222 is randomized. This allows the user to view the content in the content segments 222 and, upon finding content of interest, move that content into the center area 230 for additional information.

In other examples, the user can provide input regarding what content is shown in the content segments. One example of such a configuration is described below.

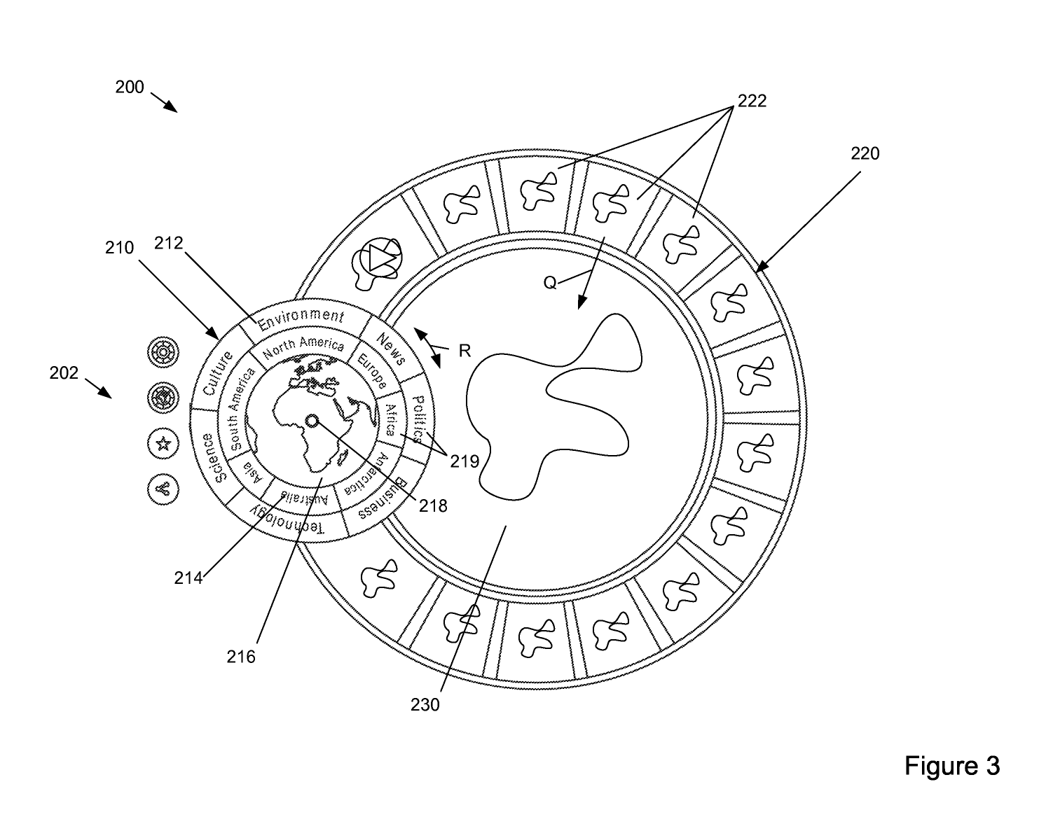

Referring now to FIG. 3, the interface 200 is shown again with the navigation member 220. In addition, the interface includes an optional control member 210. Generally, the control member 210 allows the user to control the type of content that is displayed in the content segments 222.

The control member 210 is a series of concentric circles, including a first control 212 and a second control 214. A central member 216 is positioned in the middle of the control member 210, surrounded by the first and second controls 212, 214.

Each of the first control 212 and the second control 214 is segmented into a plurality of sections. Each of the sections can be representative of different categories associated with the content, such as categories and subcategories of content, respectively. In this example, the first control 212 and the second control 214 are independently rotated (e.g., using a mouse, touch, etc.) in directions R about the central member 216 to select the desired category and subcategory.

As a specific category and subcategory are aligned, as shown by aligned segments 219, the central member 216 is modified to represent an aspect of the aligned segments 219. For example, if one or more of the categories relate to geography, the central member 216 can provide a visualization of a globe, and an indicator 218 is used to identify the specific geographic area selected by one or both of the aligned segments 219.

As the user spins the first control 212 and the second control 214 to select the desired aligned segments 219, content shown in the navigation member 220 and the center area 230 is modified.

Content is illustrated in one or more of the content segments 222 based on the aligned segments 219 of the control member 210. For example, as the user spins the first control 212 and the second control 214 in directions R, the content shown in the content segments 222 is changed to reflect the aligned segments 219.

In addition, content is shown in the center area 230. In an example, the content defaults to one aspect associated with the aligned segments 219. A user can select any of the content segments 222 to place the selected content “in-focus” within the center area 230. In doing so, additional information regarding the content from the selected segment 222 is shown, as describe below.

Controls 202 are also provided with the interface 200. Controls 202 allow the user to control various aspects of the interface. For example, the controls 202 allow the user to set a favorite associated with a particular configuration for the interface 200, such as the specific position of the first control 212 and the second control 214. In another example, the controls 202 allow the user to easily share selected content using social media (e.g., Facebook or Google+) or messaging (e.g., email, instant message, or text message).

In the example shown in FIG. 3, the first control 212 relates to interest topics, including Science, Culture, Environment, News, Politics, Business, and Technology. The second control 214 relates to geography, including the continents (i.e., Asia, South America, North America, Europe, Africa, Antarctica, and Australia). Other configurations are possible.

The central member 216 is a globe that is modified depending on which geographic area is selected. For example, as depicted, the user has spun the first control 212 and second control 214 so that “Politics” and “Africa” are the aligned segments 219. In this configuration, the central member 216 is modified to highlight Africa, and the indicator 218 is positioned within the depiction of Africa on the globe. As the user spins the second control 214 in the directions R, the aligned country is changed, and the globe and indicator 218 shown in the central member 216 are modified appropriately.

With the selected first control 212 and second control 214 aligned, content associated with politics in Africa is shown in the navigation member 220. Specifically, one or more of the content segments 222 includes content associated with politics in Africa, such as images, video, audio, and/or text related to the subject.

As the user spins the first control 212 and second control 214, the content shown in the navigation member 220 is modified appropriately. For example, if the user is to spin the first control 212 so that “Business” is selected, the navigation member 220 is modified to show content associated with business in Africa. In this example, the content is images and video associated with business in Africa.

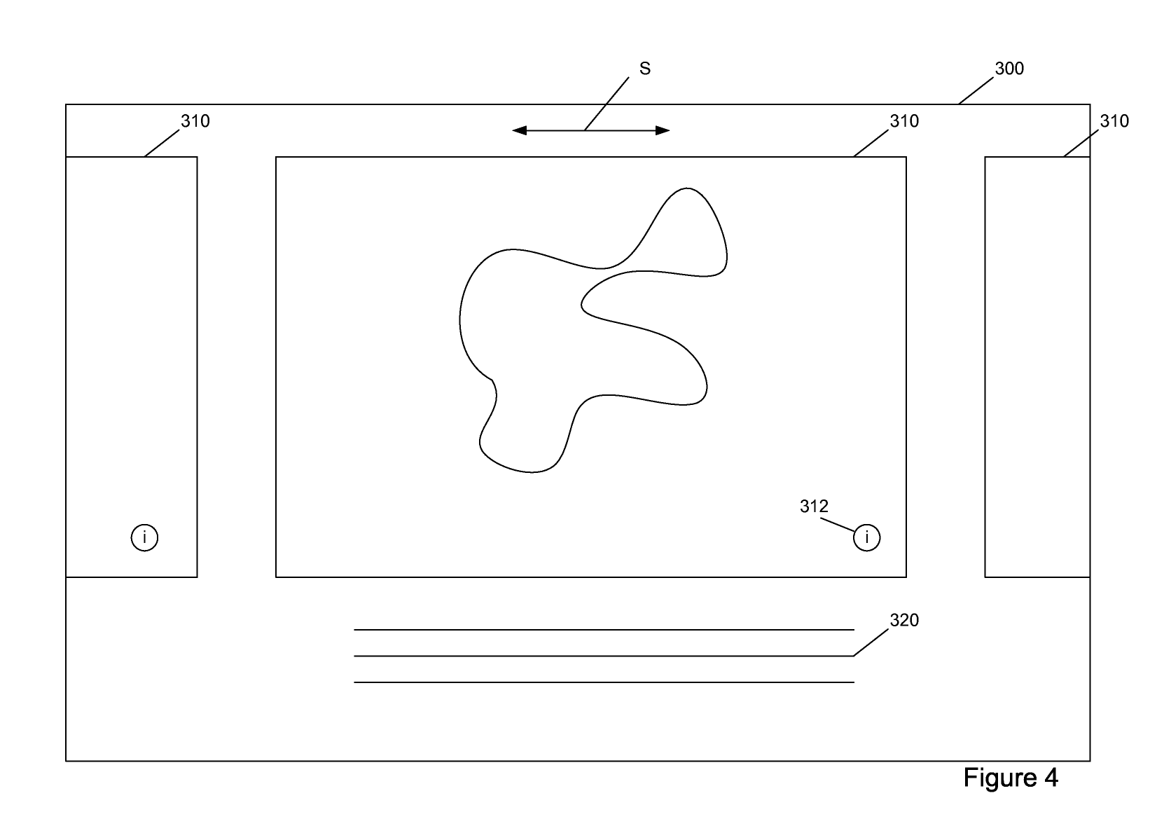

Once the user identifies content of interest, the user can drag that content into the center area 230 to obtain additional information about that content. This is illustrated in FIG. 4, in which another user interface 300 is shown. In this example, once a user selects content from the navigation member 220 and drags the content into the center area 230, the interface 300 is displayed.

The interface 300 includes content windows 310 that illustrate content related to the selection made by the user. For example, if the user selects an image from the navigation member 220 in the interface 200, the content window 310 illustrates that image in larger dimension. Adjacent content windows 310 illustrate content that is related to the content selected from the navigation member 220 in the interface 200, such as other images, videos, etc. The user can cycle through the content windows 310 by dragging the content windows 310 in directions S.

Additional information about the content window 310 is provided at an explanation section 320. In some examples, the explanation section 320 provides a textual description of the content in the content window 310, such as a description of what the content, where it originates, and the general relevance of the content.

In addition, an information icon 312 is provided in the content window 310. The information icon 312 can be selected by the user to obtain further information associated with the content shown in the content window 310.

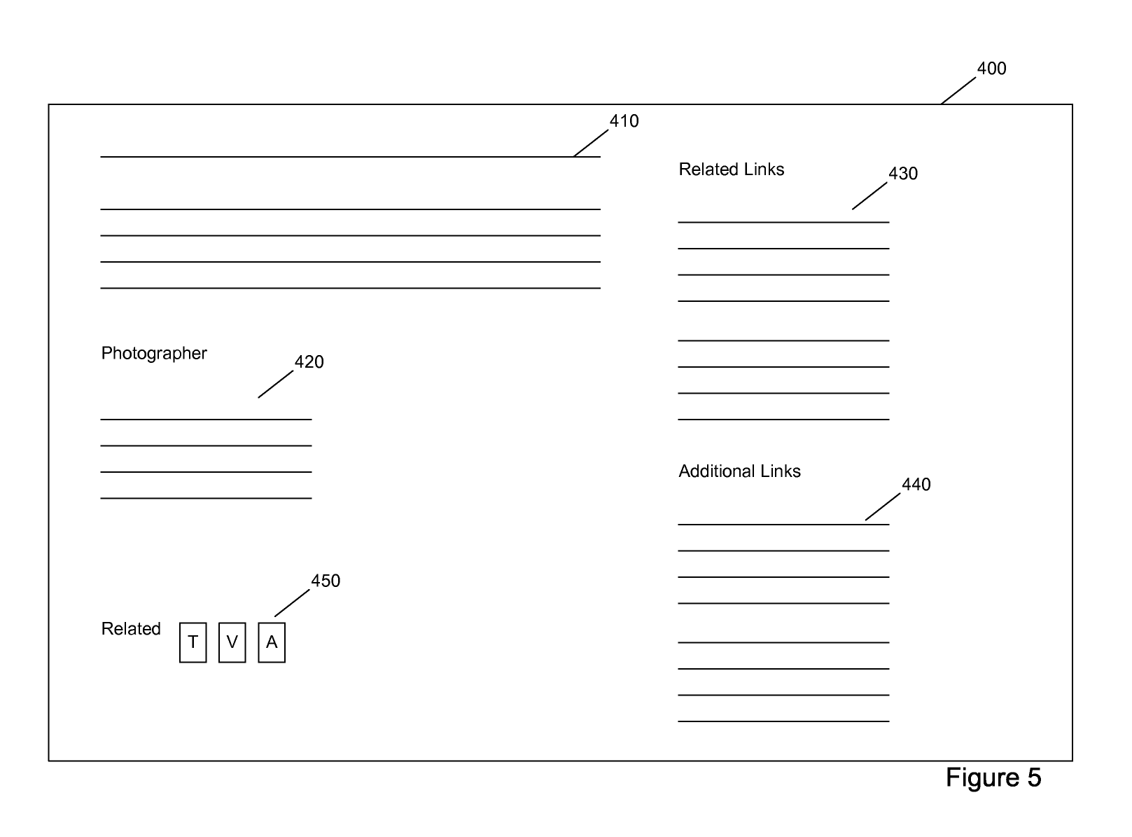

For example, referring now to FIG. 5, when a user selects the information icon 312 within the content window 310, a user interface 400 is provided. The interface 400 provides additional context related to the content shown in the content window 310.

In this example, the interface 400 includes an explanation section 410 that provides an additional description related to the content, such as a more detailed description of the content. For example, if the content is an image, the explanation section 410 can provide an explanation of where the image was taken, what the image depicts, and any context surrounding the image.

A content origin section 420 provides an origin for the content depicted in the content window 310. For example, if the content is an image, the content origin section 420 can provide the name of the person creating the image (e.g., the photographer), as well as contact information for that person.

The interface 400 also includes a related links section 430 and an additional links section 440. These sections 430, 440 provide additional information about the content. For example, the related links section 430 can provide hyperlinks that allow the user to access additional content on the system 100 that is related to the selected content. The additional links section 440 provides links to content on other systems, such as news content, related to the selected content.

Finally, a related section 450 provides content that is related to the selected content. For example, if the selected content is an image, the related section 450 can provide links to text, video, or audio associated with the image, such as audio recorded when the image was taken, or video of the area where the image was taken.

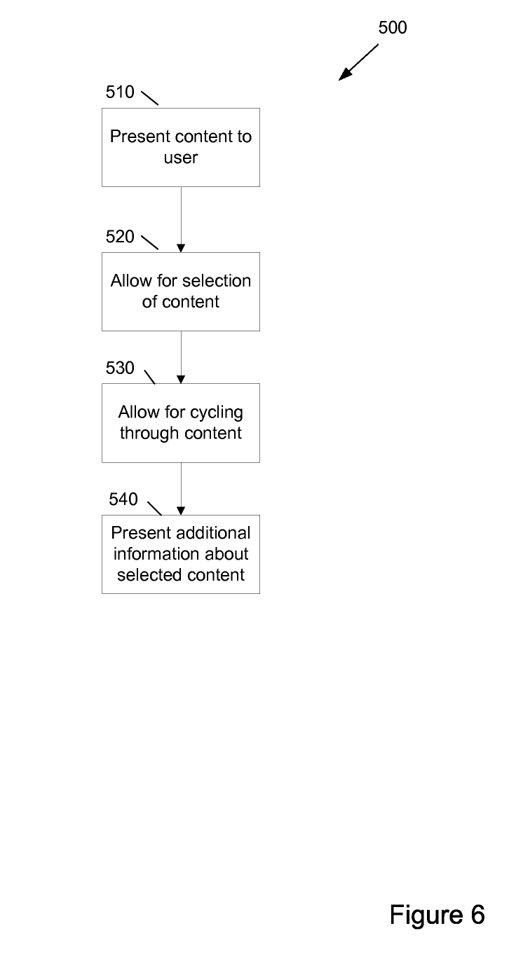

Referring now to FIG. 6, an example method 500 for using the system 100 is shown.

Initially, at operation 510, the user is presented with content. As described, this content can be periodically updated and/or the user can control the content shown.

Next, at operation 520, the user is allowed to select specific content. This selection can be accomplished, for example, by dragging the content into the center area.

At operation 530, the user is allowed to cycle through related content. Finally, at operation 540, the user is allowed to access additional information associated with the content using, for example, the interface 400.

The example systems and methods described herein provide the user with an intuitive and efficient manner to navigate through content to identify desired content. For example, the user can visually navigate through content using the navigation member and control member, if provided. When desired content is identified, the user can thereupon obtain additional information about that content in an efficient fashion.

Although examples are described herein, alternatives are possible. For example, although the embodiment of the control member is shown with topics and geography, alternatives can include other information. For example, the control member could include a category and subcategory (e.g., music and genre), or could include more than two categories, such that the control member includes three concentric circles that are rotated and aligned to make a selection, thereby making the selection three dimensional.

In addition, although the examples shown include content such as images and video, other content can also be navigated. For example, the dial member and iris can provide depictions of music labels, and the control member can be used to navigate through the music, such as by selecting genre and musician. The system can likewise be used to navigate through other types of content.

In yet another example, the dial member can be configured so that the user can rotate the dial member as desired to obtain additional content related to the selection made using the control member. For example, if images are provided on the dial member, the user can rotate the dial member so that additional images relating to the selected content are shown.

In a further embodiment, the dial member can include another concentric circle with a plurality of content segments. These content segments of the concentric circles can be aligned by the user to make additional selections, thereby adding a third dimension to the selection. Based on the selection made using the dial member, the content shown in the navigation member can be modified accordingly.

In another example, other controls can be used to allow the user to select the content that is shown in the navigation member. For example, instead of concentric circles, one or more dropdown boxes can be provided that allow the user to select the parameters associated with the content that is shown. Other configurations are possible.

In addition, the central member and associated indicator of the control member can be modified depending on the type of content presented. For example, if the control member is used to navigate music genres, the central member can depict a landscape of the types of genres, and the indicator can be used to illustrate where the aligned genre sits within the landscape.

The various embodiments described above are provided by way of illustration only and should not be construed to limiting. Various modifications and changes that may be made to the embodiments described above without departing from the true spirit and scope of the disclosure.

What is claimed is:

1. A computing device for online idea collaboration, the computing device comprising:
a processor; and
a computer readable storage medium encoding instructions that, when executed by the processor, cause the processor to create a user interface including a navigation member having a plurality of content segments, the content segments extending in a circular configuration, with each of the content segments including content, and the navigation member including a center area into which content from one of the content segments is dragged to obtain additional information about that content.

2. The computing device of claim 1, wherein the computer readable storage medium encodes further instructions that, when executed by the processor, cause the processor to create a control member including a first control and a second control, the first control being a first circle, and the second control being a second circle located concentrically within the first circle, wherein each of the first control and the second control is rotatable so that segments of the first control and the second control are aligned to select content.

3. The computing device of claim 2, wherein the first control and the second control select content that is displayed on the content segments.

4. The computing device of claim 1, wherein the content segments form a circle.

5. The computing device of claim 1, wherein the navigation member forms an iris shape.

6. The computing device of claim 1, wherein content in the content segments is updated periodically.

7. The computing device of claim 1, wherein content in each of the content segments is updated in a staggered manner.

8. The computing device of claim 1, wherein content in each of the content segments is randomized.

9. A system, comprising:
a server computing device that receives a request for content from a client, the server computing device including:
a processor; and
a computer readable storage medium encoding instructions that, when executed by the processor, cause the processor to create a user interface including a navigation member having a plurality of content segments, the content segments extending in a circular configuration, with each of the content segments including content, and the navigation member including a center area into which content from one of the content segments is dragged to obtain additional information about that content.

10. The system of claim 9, wherein the computer readable storage medium encodes further instructions that, when executed by the processor, cause the processor to create a control member including a first control and a second control, the first control being a first circle, and the second control being a second circle located concentrically within the first circle, wherein each of the first control and the second control is rotatable so that segments of the first control and the second control are aligned to select content.

11. The system of claim 10, wherein the first control and the second control select content that is displayed on the content segments.

12. The system of claim 9, wherein the content segments form a circle.

13. The system of claim 9, wherein the navigation member forms an iris shape.

14. The system of claim 9, wherein content in the content segments is updated periodically.

15. The system of claim 9, wherein content in each of the content segments is updated in a staggered manner.

16. The system of claim 9, wherein content in each of the content segments is randomized.

17. A method of accessing content, the method comprising:
providing, by a computing device, a navigation member having a plurality of content segments, the content segments extending in a circular configuration, with each of the content segments including content;
allowing a user to drag content from one of the content segments into a center of the navigation member; and
providing additional information regarding the content from the one of the content segments dragged into the center.

18. The method of claim 17, further comprising providing a control member including a first control and a second control, the first control being a first circle, and the second control being a second circle located concentrically within the first circle.

19. The method of claim 18, further comprising allowing the user to rotate the first control relative to the second control so that segments of the first control and the second control are aligned to select content.

20. The method of claim 19, further comprising modifying content in the content segments based upon the selected content.
